(19) United States
(12) Patent Application Publication
(10) Pub. No.: US 2006/0076824 A1
(43) Pub. Date: Apr. 13, 2006

(54) Park brake valve assembly

(75) Inventor: Thomas R. Soupal, Rochester Hills, MI (US)

Correspondence Address: CARLSON, GASKEY & OLDS, P.C., 400 WEST MAPLE ROAD, SUITE 350, BIRMINGHAM, MI, 48009, US

(73) Assignee: Meritor WABCO Vehicle Control Systems

(21) Appl. No.: 10/963,116

(22) Filed: Oct. 12, 2004

(51) Int. Cl. B60T 8/34

(52) U.S. Cl. 303/118.1

(57) ABSTRACT

A brake system for a heavy-duty vehicle includes a service brake system and a park brake system. The park brake system includes a park brake control valve that receives input commands from a vehicle operator and a park brake interlock valve that is in fluid communication with an air supply and the park brake control valve. After the park brakes are moved to an applied position, the park brakes can only be released if a park brake release command is communicated to the park brake control valve and the service brake system is in an applied position. The park brake interlock valve includes an inlet port in fluid communication with a vehicle air supply, an outlet port in fluid communication with the park brake control valve, and a valve assembly for controlling fluid flow between the inlet and outlet ports. When service brakes are applied, the valve assembly allows fluid communication from the inlet port to the outlet port, which pressurizes the park brakes to move the park brakes to the released position.

### TECHNICAL FIELD

The subject invention relates to a park brake valve assembly that requires a service brake to be applied before a park brake can be released.

### BACKGROUND OF THE INVENTION

A brake system for a heavy-duty vehicle includes a service brake system and a park brake system. The service brake system includes service brakes that are used to slow or stop the vehicle during normal vehicle operation. The park brake system includes park brakes that are moved between a released position and an applied position where wheel rotation is prevented during a parking phase. The park brake system includes a park brake control valve that receives input from an actuator located within a tractor cab of the vehicle. A vehicle operator controls the actuator to apply and release the park brakes.

Typically, the park brake control valve includes a two-way check valve that is fluidly connected upstream to an air supply and fluidly connected downstream to park brake spring chambers. In a park brake release position, air is supplied to the park brake spring chambers to hold the park brake spring chambers in the released position. In response to a park release command, air is exhausted from the park brake spring chambers, and the park brake spring chambers move the park brake into the applied position. To release the park brakes, the park brake spring chambers have to be re-pressurized with air from the air supply.

One disadvantage with this traditional configuration is that the actuator in the tractor cab can be accidentally bumped or hit by vehicle occupants or objects located within the tractor cab after the park brake has been applied. If the actuator is inadvertently or accidentally actuated after the park brake has been applied, the park brake is released and the vehicle can start to move.

Another disadvantage with the traditional configuration concerns the incorporation of the two-way check valve into the park brake control valve. The park brake control valve is located within the tractor cab close to the actuator, which is typically located on a vehicle dash. Further, the park brake control valve is fluidly connected to a primary air supply and a secondary air supply, which serves as a back-up air supply. This requires at least two different air connections to the two-way check valve. These air connections must be plumbed through the tractor, which is difficult due to packaging space constraints.

Thus, there is a need for a park brake valve assembly that reduces the number of air connections routed to the tractor, and which can prevent an accidental or inadvertent release of the park brake, in addition to overcoming the other deficiencies in the prior art discussed above.

### SUMMARY OF THE INVENTION

A park brake valve assembly includes a park brake control valve that receives apply and release commands from a vehicle operator and an interlock valve that is in fluid communication with the park brake control valve. The interlock valve is also in fluid communication with a service brake control valve. The interlock valve cooperates with the service brake control valve such that a park brake can only be released in response to a release command if a service brake is applied. This prevents an inadvertent release of the parking brake.

In one example, the interlock valve includes a valve body with at least one inlet port fluidly connected to an air supply, an outlet port fluidly connected to the park brake control valve, and a valve assembly that controls fluid communication between the inlet and outlet ports. When the service brakes are actuated, the valve assembly allows air to be supplied from the air supply at the inlet port to the outlet port. When the park brake control valve receives a release command, air from the output port is communicated to the park brake to move the park brake to a released position.

In one embodiment, the interlock valve is in fluid communication with a primary air supply and a secondary air supply. The primary and secondary air supplies preferably operate independently from each other such that if one of the primary and secondary air supplies has a failure, the other of the primary and secondary air supplies can serve as a back-up. In this configuration, the valve body includes a first inlet port in fluid communication with the primary air supply and a second inlet port in fluid communication with the secondary air supply. The valve assembly includes a first two-way check valve supported within the valve body to control fluid flow from the first and second inlet ports to the outlet port.

The service brake control valve is in fluid communication with the primary and secondary air supplies. The service brake control valve is positioned downstream of the interlock valve and upstream from the primary and secondary air supplies. The valve body also includes a third inlet port in fluid communication with the primary air supply via the service brake control valve and a fourth inlet port in fluid communication with the secondary air supply via the service brake control valve. The valve assembly includes a second two-way check valve that controls fluid flow from the third and fourth inlet ports in response to a service brake application.

A piston is slidably received within a piston chamber formed within the valve body. When the service brakes are applied, air is supplied from the primary and secondary air supplies to the third and fourth inlet ports. Depending on which of the primary and secondary air supply has the higher pressure, the second two-way check valve fluidly connects one of the third and fourth inlet ports to the piston chamber. The pressurized air supplied to the piston chamber moves the piston, which fluidly connects one of the first and second inlet ports to the outlet port. Thus, when the service brake is applied, the interlock valve is moved to an open position and the park brake can be released if a park release command is communicated to the park brake control valve.

The subject invention provides a park brake valve assembly that prevents release of a park brake unless the vehicle operator has actuated the service brakes. These and other features of the present invention can be best understood from the following specification and drawings, the following of which is a brief description.

### BRIEF DESCRIPTION OF THE DRAWINGS

FIG. 1 is a schematic view of a vehicle brake system with a park brake control valve and interlock valve assembly incorporating the subject invention wherein the interlock valve assembly is shown in an open position.

FIG. 2 is a schematic view of the interlock valve assembly of FIG. 1 in the closed position.

FIG. 3 is a schematic view of another example of an interlock valve assembly.

### DETAILED DESCRIPTION OF THE PREFERRED EMBODIMENT

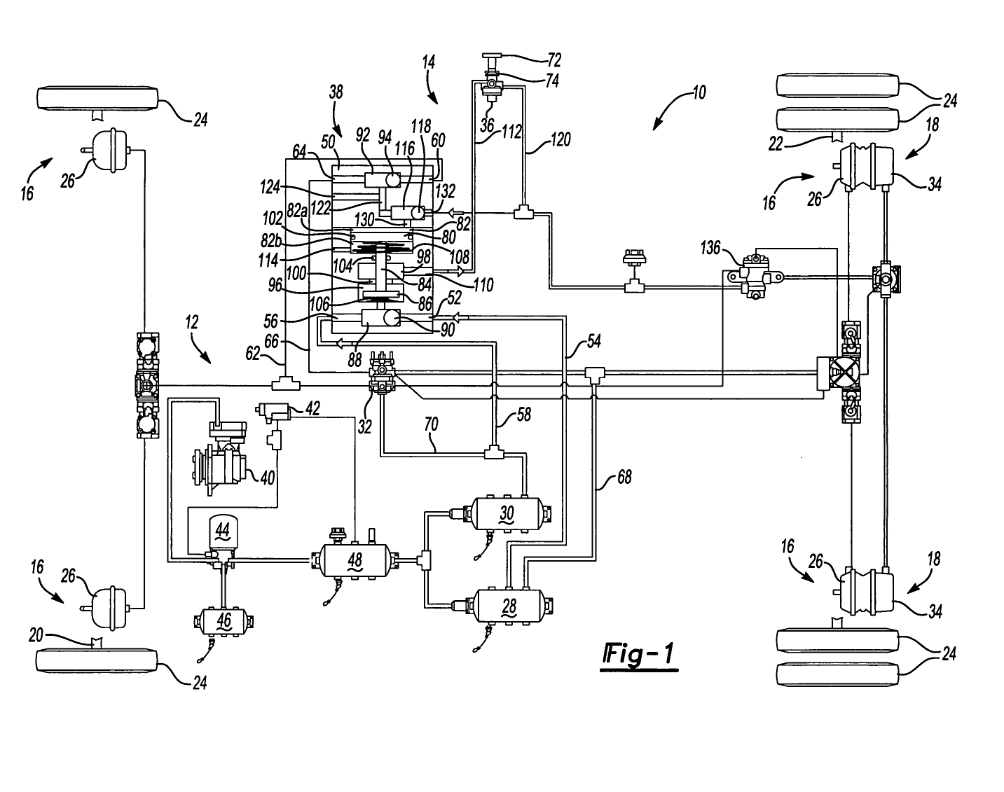

A brake system 10 for a heavy-duty vehicle includes a service brake system 12 and a park brake system 14 shown in FIG. 1. The service brake system 12 includes service brakes 16 that are used to slow or stop the heavy-duty vehicle during normal vehicle operation. The park brake system 14 includes park brakes 18 that are moved between an applied position and a released position.

The heavy-duty vehicle typically includes a front axle 20 and a rear axle 22. The front axle 20 is typically a steer axle and could be a drive or non-drive axle. The rear axle 22 is typically a single drive axle or a tandem drive axle. FIG. 1 shows a single drive axle, however, it should be understood that the subject park brake system 14 could also be used on a tandem drive axle.

The front 20 and rear 22 axles each include a set of wheels 24. Each wheel 24 includes a service brake 16. In the example shown, each service brake 16 includes a brake actuator 26 that is connected to a primary air supply 28 and a secondary air supply 30 via a service brake control valve 32. The primary 28 and secondary 30 air supplies preferably operate independently from each other, such that if one of the primary 28 and secondary 30 air supplies has a failure, the other of the primary 28 and secondary 30 air supplies can serve as a back-up.

When a vehicle operator actuates the service brakes 16, via a foot pedal (not shown) or some other similar brake actuating mechanism, the service brake control valve 32 delivers air from one of the primary 28 or secondary 30 air supplies to the service brakes 16 for the front 20 and rear 22 axles. The air pressurizes the spring chambers to apply the service brake 16 at each wheel 24. When the vehicle operator releases the service brakes 16, air is exhausted from the spring chambers 26 to release the service brakes 16 at each wheel 24.

In the example shown in FIG. 1, each wheel 24 on the rear axle 22 includes a park brake 18. Each park brake 18 includes a park brake spring chamber 34 that is connected to the primary 28 and secondary 30 air supplies via a park brake control valve 36 and an interlock valve assembly 38. During normal vehicle operation, the park brake spring chambers 34 are pressurized to hold the park brakes 18 in a released position. When the vehicle operator communicates a park brake apply command to the park brake control valve 36, air is exhausted from the park brake spring chambers 34 and the park brakes 18 are applied. It should be understood that while FIG. 1 shows park brakes 18 only on the rear axle 22, the front axle 20 could also include park brakes 18.

The brake system 10 includes a compressor 40 and air governor 42 that are fluidly connected to an air dryer 44. The air dryer 44 includes a purge 46 for purging water and other contaminants. The primary 28 and secondary 30 air supplies are each fluidly connected to a wet tank 48 that is located downstream from the air dryer 44. The wet tank 48 removes any remaining moisture from the air before the air is supplied into the primary 28 and secondary 30 air supplies. The operation of the compressor 40, air governor 42, air dryer 44, purge 46, and wet tank 48 are well-known and will not be discussed in further detail.

The interlock valve assembly 38 and the park brake control valve 36 cooperate such that the park brakes 18 can only be released in response to a park release command if the services brakes 16 are applied. In other words, once the park brakes have been moved into the applied position, the vehicle operator must actuate the service brake 16 before the park brakes 18 can be moved to the released position. The interlock valve assembly 38 is moveable between an open position where air from the primary 28 or secondary 30 air supply is communicated to the park brake control valve 36 and a closed position where air is prevented from being communicated to the park brake control valve 36.

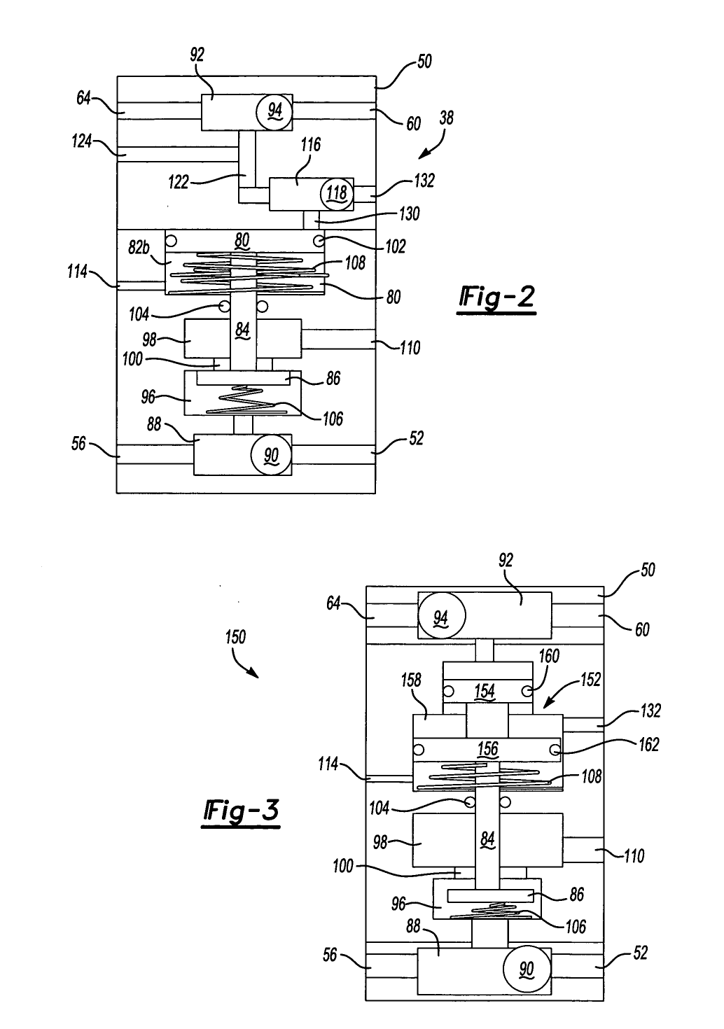

The interlock valve assembly 38 is shown in an open position in FIG. 1 and in the closed position in FIG. 2. The interlock valve assembly 38 is located upstream from the park brake control valve 36, which reduces the number of air connections that extend into a cab portion of the heavy-duty vehicle. This will be discussed in greater detail below.

The interlock valve assembly 38 includes a valve body 50 having a first inlet port 52 fluidly connected to the primary air supply 28 with a first connecting line 54, and a second inlet port 56 fluidly connected to the secondary air supply 30 with a second connecting line 58. The valve body 50 also includes a third inlet port 60 fluidly connected to the service brake control valve 32 with a third connecting line 62 and a fourth inlet port 64 fluidly connected to the service brake control valve 32 with a fourth connecting line 66. The service brake control valve 32 is fluidly connected to the primary air supply 28 with a fifth connecting line 68 and is also fluidly connected to the secondary air supply 30 with a sixth connecting line 70. Thus, the first 52 and second 56 inlet ports are in direct fluid communication with the primary 28 and secondary 30 air supplies, while the service brake control valve 32 controls fluid communication between the third 60 and forth 64 inlet ports and the primary 28 and secondary 30 air supplies.

The first 54, second 58, third 62, fourth 66, fifth 68, and sixth 70 connecting lines can be formed from any type of connecting line known in the art including rigid tubing members or rubber hose lines, for example. Further, the first 54, second 58, third 62, fourth 66, fifth 68, and sixth 70 connecting lines are just one example of a connecting configuration that could be used to interconnect the interlock valve assembly 38 with the park brake control valve 36 and the primary 28 and secondary 30 air supplies. The interlock valve assembly 38 could be integrated into the service brake control valve 32 and/or park brake control valve 36 to reduce the number of connecting lines.

The park brake control valve 36 is operably connected to a park brake actuator 72, located within the cab portion of the heavy-duty vehicle. Typically, the park brake actuator 72 is located with a vehicle dash so that the vehicle operator can easily control the park brake actuator 72. The park brake actuator 72 can be a button, lever, or other similar mechanism and includes a resilient member 74 that resiliently biases the park brake actuator in the applied position. If the service brake 16 is not applied when the vehicle operator attempts to move the park brake actuator 72 to a released position, the resilient member 74 will return the park brake actuator 72 to the applied position, which provides a visual indication to the vehicle operator that the park brakes 18 have not been released. The interlock valve assembly 38 is preferably located remote from the park brake actuator 72 and away from the vehicle dash to reduce the number of air connections that would be routed into the cab portion.

The interlock valve assembly 38 also includes a piston 80 slidably received within a piston chamber 82 formed within the valve body 50. A piston shaft 84 is coupled to the piston 80 at one end and cooperates with a valve disc 86 at an opposite end. A first valve chamber 88 is formed within the valve body 50 between the first 52 and second 56 inlet ports. A first two-way check valve 90 is received within the first valve chamber 88. A second valve chamber 92 is formed within the valve body 50 between the third 60 and fourth 64 inlet ports. A second two-way check valve 94 is received within the second valve chamber 92. The piston 80, piston shaft 84, valve disc 86, and piston chamber 82 are positioned within the valve body 50 between the first 88 and second 92 valve chambers.

The valve disc 86 is received within a disc chamber 96, which is spaced apart from the piston chamber 82. An intermediate chamber 98 is formed within the valve body 50 between the piston 82 and disc 96 chambers. The piston shaft 84 extends from the piston 80 through an opening, into the intermediate chamber 98, and terminates at the valve disc 86 in the disc chamber 96. The intermediate chamber 98 and disc chamber 96 are fluidly connected with each other by a passage 100. The piston 80 is sealed against an inner wall of the piston chamber with a first seal 102 and the piston shaft 84 is sealed within the opening with a second seal 104. Thus, air does not flow between the piston chamber 82 and the intermediate chamber 98.

A first spring 106 reacts between a wall of the disc chamber 96 and the valve disc 86. A second spring 108 reacts between a wall of the piston chamber 82 and the piston 80. The valve disc 86 is smaller in size than the disc chamber 96 such that when the interlock valve assembly 38 is in the open position, air can flow from the first valve chamber 88 into the disc chamber 96, around the valve disc 86, and into the intermediate chamber 98.

The valve body 50 also includes an outlet port 110, which is fluidly connected to the park brake control valve 36 with a seventh connecting line 112. The outlet port 110 is in fluid communication with the intermediate chamber 98.

The piston chamber 82 is separated by the piston 80 into a first chamber portion 82a and a second chamber portion 82b. The second spring 108 is located within the second chamber portion 82b. A vent 114 is formed within the valve body 50 to allow air from the second chamber portion 82b to be vented to atmosphere when the second spring 108 is compressed as the interlock valve assembly 38 is moved from the closed position to the open position.

The interlock valve assembly 38 also includes a third valve chamber 116 that receives a third two-way check valve 118. The third valve chamber 116 is fluidly connected to a park brake air connecting line 120 downstream of the park brake control valve 36. The park brake air connecting line 120 fluidly connects the park brake control valve 36 to the park brakes 18 on the rear axle 22. The third valve chamber 116 is also fluidly connected to the second valve chamber 92 via a passage 122. The third two-way check valve 118 controls air flow from the park brake air connecting line 120 to the first chamber portion 82a of the piston chamber 82 and controls air flow from the second valve chamber 92 to the first chamber portion 82a.

The valve body 50 could also include an optional passage 124 for communicating with a switching mechanism, such as a pressure switch, for example. One example of a switching mechanism that could benefit from this configuration is a stoplight switch that could indicate that service brakes 16 have been applied so that park brakes 18 can be released. Other switches could also be incorporated into the valve body in addition to the stoplight switch, or in place of the stoplight switch. Examples of other switches include low pressure warning switches, park brake indicator switches, etc.

As discussed above, the park brakes 18 cannot be released unless the service brake 16 is applied at the same time that the park brake actuator 72 is moved to a release position. The interlock valve assembly 38, park brake control valve 36, and service brake control valve 32 cooperate to provide this feature in the following manner. Air from the primary 28 and secondary 30 air supplies enter the valve body 50 through the first two-way check valve 90 to provide blended air to the park brake control valve 36 via the interlock valve assembly 38. This eliminates the need for a two-way check valve in the park brake control valve 36 itself, such as would occur in a traditional configuration. This means that one air connecting line is removed from cab installation.

The first two-way check valve 90 is controlled by whichever of the primary 28 or secondary 30 air supplies has the higher air pressure. In the example shown in FIG. 1, the secondary air supply 30 has the higher air pressure, thus the first two-way check valve 90 is moved to the right and air can pass the first two-way check valve 90. Normally, the interlock valve assembly 38 is in the closed position as shown in FIG. 2, where the valve disc 86 is seated against the valve body 50 such that air cannot flow from the disc chamber 96 to the intermediate chamber 98. The first spring 106 should have a spring force that is sufficient to hold the valve disc 86 in the closed position such as when the service brakes 16 are not applied and the park brake 18 is in the applied position.

Once the park brakes 18 are in the applied position, if the park brake actuator 72 is moved to a park release position nothing happens because the outlet port 110 cannot deliver air to the park brake control valve 36 due to the position of the valve disc 86. Without supply air, the park brake control valve 36 cannot deliver air to release the park brake spring chambers 34. Additionally, the park brake actuator 72 cannot stay in the park release position once the vehicle operator releases the park brake actuator 72 because the resilient member 74 returns the park brake actuator 72 to the park applied position. This provides visible evidence to the vehicle operator that the park brakes 18 are not released.

If the service brakes 16 are applied, control pressure is delivered from the service brake control valve 32 to the second two-way check valve 94. The dominant control pressure from the primary 28 or secondary 30 air supply passes through the second two-way check valve 94 and then enters the third valve chamber 116. Air flows from the third valve chamber 116 and into the first chamber portion 82a of the piston chamber 82 via passage 130. This air pressure forces the piston 80 down to compress the second spring 108. This also moves the piston shaft 84 to engage and move the valve disc 86. Movement of the valve disc 86 compresses the first spring 106 and moves the interlock valve assembly 38 to the open position by unseating the valve disc 86.

In the open position, the valve disc 86 allows air from the primary 28 and secondary 30 air supplies to be sent out via the outlet port 110 to the park brake control valve 36. If the park brake actuator 72 is now moved into the release position, then air passes through the park brake control valve 36 and into the park brake air connecting line 120 to release the spring set park brakes 18. The same air that releases the park brakes 18 is also sent to an inlet port 132 of the third valve chamber 116. This air passes through the third two-way check valve 118 and replaces service brake control air when the vehicle operator releases the service brake 16. In other words, after a service brake application, the seventh connecting line 112 remains pressurized and the third two-way check valve 118 is moved to the left in FIG. 1. This provides air to hold down the piston 80 as long as the park brake actuator 72 is in the release position.

When the park brake actuator 72 is moved to the park or applied position, the air holding the park brakes 18 in the released position is allowed to vent to atmosphere through an exhaust port in the park brake control valve 36 or via a quick release valve 136. When the park brakes 18 are exhausted, then the inlet port 132 is also exhausted, which allows the first 106 and second 108 springs to push the valve disc 86 and piston 80 to the closed position. Once in the closed position, air cannot be supplied to the park brake control valve 36 until the service brake 16 is applied.

An optional interlock valve assembly 150 is shown in FIG. 3. This configuration is similar to that of FIGS. 1 and 2 except that the third two-way check valve 118 is replaced with a double piston assembly 152. In this configuration, the double piston assembly 152 includes an upper piston 154 that is moved in response to air flow into the second valve chamber 92, and a lower piston 156 that moves downward in response to movement of the upper piston 154 to unseat the valve disc 86. When the valve disc 86 is unseated, i.e. when the service brake 16 is applied, air flows from the first valve chamber 88 to the outlet port 110 via the intermediate chamber 98 as described above. The inlet port 132 communicates with an intermediate piston chamber 158 to replace service brake control air when the vehicle operator releases the service brake 16 in a manner similar to that described above with regard to the third two-way check valve 118. The upper piston 154 is sealed with a first seal 160 and the lower piston 156 is sealed with a second seal 162 to prevent air flow from the intermediate piston chamber 158 into either the second valve chamber 92 or the intermediate chamber 98.

The subject brake system 10 provides many benefits including the prevention of a park brake release in response to an accidental or inadvertent movement of the park brake actuator 72 to the release position. Further, passengers and/or objects moving about within the cab portion cannot accidentally release the park brake 18. Additionally, if a vehicle operator is in a driver seat and releases the park brake 18 in combination with applying the service brake 16, vehicle “rollaway” is prevented because the vehicle operator's foot is already on the service brake 16.

Another advantage is that the second spring 108 can be configured to provide a spring force set at a minimum pressure value that would automatically block the supply air required to hold park brakes 18 in the release position if pressure fell below the minimum pressure value. If, for example, both the primary and secondary air systems were experiencing leaks, overall pressure can fall as low as 40 psi. Traditionally, if the pressure falls to 40 psi, the park brake control valve is activated to exhaust all air to apply the park brakes 18. The vehicle operator may attempt to drive the vehicle by holding the park brake control valve in the release position to “limp home” with only 40 psi pressure in the braking system. To prevent this “limp home” mode, the second spring 108 in the interlock valve assembly 38 is biased to automatically move the interlock valve assembly 38 to the closed position if pressure falls below a predetermined pressure valve. The vehicle operator cannot override the application of the second spring 108.

Other advantages include combining a supply check valve, i.e. the first two-way check valve 90, and switching mechanisms, via optional passage 124, into a common valve body 50. This reduces plumbing connections and potential leak points. Further the interlock valve assembly 38 is installed upstream of the park brake control valve 36 where plumbing lines, i.e. connecting lines, are shorter and less exposed to damage.

The subject invention is reliable, simple in construction, and has no failure modes that might unintentionally release the park brakes 18. Also, the interlock valve assembly 38 includes a second two-way check valve 94 that insures operation in the event of a primary or secondary air supply failure.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A park brake valve assembly comprising:
a park brake control valve operable to move a park brake between a park brake applied position and a park brake released position; and
an interlock valve assembly including an interlock valve body having at least one inlet port in fluid communication with an air supply and an outlet port in fluid communication with said park brake control valve, said interlock valve assembly being movable between an open position where air from the air supply is supplied to said outlet port and a closed position where air from the air supply is prevented from being supplied to said outlet port, and wherein the park brake is moved to the park brake released position when a park brake release command is communicated to said park brake control valve and said interlock valve assembly is in the open position.

2. The park brake valve assembly according to claim 1 wherein said interlock valve assembly fluidly connects said at least one inlet port to said outlet port in response to a service brake application to move said interlock valve assembly from said closed position to said open position.

3. The park brake valve assembly according to claim 1 wherein said interlock valve assembly is positioned upstream from said park brake control valve.

4. The park brake valve assembly according to claim 1 wherein said interlock valve assembly includes a first two-way check valve and wherein said at least one inlet port includes a first inlet port and a second inlet port, said first two-way check valve being in fluid communication with said first and said second inlet ports.

5. The park brake valve assembly according to claim 4 wherein the air supply includes a primary air supply fluidly connectable to said first inlet port and a secondary air supply fluidly connectable to said second input port.

6. The park brake valve assembly according to claim 5 including a service brake control valve in fluid communication with the primary and the secondary air supplies and wherein said at least one inlet port includes a third inlet port in fluid communication with the primary air supply and a fourth inlet port in fluid communication with the secondary air supply, said service brake control valve fluidly connecting the primary air supply to the third inlet port and fluidly connecting the secondary air supply to said fourth inlet port in response to a service brake application.

7. The park brake valve assembly according to claim 6 including a piston resiliently biased to hold the interlock valve assembly in the closed position until service brakes are applied.

8. The park brake valve assembly according to claim 7 wherein said piston is slidably received within a piston chamber formed within said interlock valve body and wherein said interlock valve assembly includes a second two-way check valve in fluid communication with said third and said fourth inlet ports and in fluid communication with said piston chamber, said second two-way check valve fluidly connecting one of said third and said fourth inlet ports to said piston chamber in response to the service brake application.

9. The park brake valve assembly according to claim 1 wherein the park brake is only moved from the park brake applied position to the park brake released position when a service brake is actuated in combination with said park brake control valve receiving the park brake release command.

10. A park brake system comprising:
a park brake control valve adapted to receive park apply and park release commands;
an interlock valve assembly in fluid communication with an air supply and said park brake control valve; and
a service brake control valve in fluid communication with said interlock valve assembly wherein said service brake control valve cooperates with said interlock valve assembly to fluidly connect the air supply to said park brake control valve to release a park brake in response to a park release command in combination with a service brake application.

11. The park brake system according to claim 10 wherein said interlock valve assembly is positioned upstream from said park brake control valve.

12. The park brake system according to claim 11 including
a primary air supply;
a secondary air supply for supplying air independently from said first air supply;
wherein said service brake control valve is in fluid communication with said primary and said secondary air supplies, said service brake control valve being operable to deliver air to a service brake in response to a service brake command;
wherein said park brake control valve is in fluid communication with said primary and said secondary air supplies, said park brake control valve being operable to move the park brake between a park brake released position and a park brake applied position; and
wherein said interlock valve assembly includes
an interlock valve body including a plurality of inlet ports with each inlet port being in fluid communication with one of said primary and said secondary air supplies,
an outlet port in fluid communication with said park brake control valve,
a first two-way check valve in fluid communication with said primary and said secondary air supplies,
a second two-way check valve in fluid communication with said service brake control valve, and
a piston slidably received within a piston chamber formed within said interlock valve body, said interlock valve assembly being moveable between an open position wherein said first two-way check valve fluidly connects one of said primary and said secondary air supplies to said outlet and a closed position wherein said piston prevents fluid connection between said primary and said secondary air supplies and said outlet and wherein the park brake is moved to the park brake release position when the park release command is communicated to said park brake control valve and said interlock valve assembly is in the open position.

13. The park brake system according to claim 12 wherein said plurality of inlet ports comprises a first inlet port fluidly connecting said first two-way check valve to said primary air supply, a second inlet port fluidly connecting said first two-way check valve to said secondary air supply, a third inlet port fluidly connecting said second two-way check valve to said primary air supply via said service brake control valve, and a fourth inlet port fluidly connecting said second two-way check valve to said secondary air supply via said service brake control valve and wherein said second two-way check valve allows fluid communication between one of said third and said fourth inlet ports and said piston chamber in response to a service brake application to move said interlock valve assembly to said open position.

14. The park brake system according to claim 13 wherein said first two-way check valve allows fluid communication between one of said first and said second inlet ports and said outlet port when said interlock valve assembly is in said open position.

15. The park brake system according to claim 14 including a third two-way check valve in fluid communication with said park brake control valve and said piston chamber wherein said third two-way check valve provides fluid pressure against said piston to maintain said interlock valve assembly in said open position subsequent to a service brake application and prior to a park brake application.

16. The park brake system according to claim 10 wherein the park brake is only moved from a park brake applied position to a park brake released position when service brakes are applied and said park brake control valve receives the park release command.

17. A method for controlling operation of a vehicle park brake comprising the steps of:
(a) actuating a service brake;
(b) initiating a park brake release command; and
(c) releasing a park brake from an applied position subsequent to step (b) and only in response to a combination of steps (a) and (b).

18. The method according to claim 17 including providing an interlock valve assembly including an interlock valve body having at least one inlet port in fluid communication with an air supply and an outlet port in fluid communication with a park brake control valve; and opening the interlock valve assembly to allow direct fluid communication between the at least one inlet port and the outlet port in response to step (a).

19. The method according to claim 18 wherein the at least one inlet port includes at least a first inlet port and a second inlet port and including the steps of providing a piston slidably received within a piston chamber formed within the interlock valve body, providing a first valve assembly fluidly connecting the first inlet port to the outlet port, providing a second valve assembly fluidly connecting the second inlet port to the piston chamber, and actuating the second valve assembly to pressurize the piston chamber in response to step (a).

20. The method according to claim 18 including positioning the interlock valve assembly upstream from the park brake control valve.
